(19) United States
(12) Patent Application Publication
(10) Pub. No.: US 2018/0165083 A1
(43) Pub. Date: Jun. 14, 2018

(54) Storing and Updating Shared Data for Use with Multiple Concurrent Versions of Software

(71) Applicant: Halliburton Energy Services, Inc., Houston, TX (US)

(72) Inventors: Nathan P. Leach, Houston, TX (US); Leonid Byaly, Houston, TX (US)

(73) Assignee: Halliburton Energy Services, Inc., Houston, TX (US)

(21) Appl. No.: 15/373,143

(22) Filed: Dec. 8, 2016

(51) Int. Cl. G06F 9/445; G06F 17/30; G06F 9/44

(52) U.S. Cl. CPC G06F 8/65; G06F 8/71; G06F 17/30595

(57) ABSTRACT

An update service is initiated on a computer that has a local repository, a database storing metadata, and a software having a version. The update service communicates with a central repository connected to the local repository to determine that new metadata is available for one or more versions of the software. The update service copies from the central repository to the local repository the new metadata and an indication of the versions of software for which the new metadata is compatible. The update service updates a relation that identifies the metadata versions that are valid for each version of the software with the new metadata and an indication of which versions of the software are compatible with the new metadata. It is determined that, according to the relation, the version of the software is compatible with the new metadata and updates the database with the new metadata.

### BACKGROUND

Versions of client software may be embedded into many different client computers. A particular version of client software may require metadata that is compatible with one version of the client software, but not another version of the client software, which may cause issues when incompatible metadata is accessed. Updating multiple versions of client software with metadata is a challenge.

### BRIEF DESCRIPTION OF THE DRAWINGS

FIG. 1 is a block diagram illustrating a system for updating versions of a client software.

FIG. 2A is a diagram illustrating a query result queried against a local repository when all metadata is tagged as compatible for all released versions of the client software.

FIG. 2B is a diagram illustrating a query result when a newer metadata is added that is compatible with all released versions of the client software.

FIG. 3A is a diagram illustrating a query result when a newer metadata is added that is not compatible with all released versions of the client software.

FIG. 3B is a diagram illustrating a query result when an update to an existing metadata is incompatible with an older version of the client software.

FIG. 4 is a diagram illustrating the data retrieved when the local repository is queried by Version 2 of the client software of FIG. 3B.

FIG. 5 is a swim lane diagram illustrating an update management service using an algorithm for checking the availability of newer metadata.

FIG. 6 is a swim lane diagram illustrating an update management service using an algorithm for performing metadata updates.

FIG. 7 is a continuation of FIG. 6 illustrating the update management service using the algorithm for performing metadata updates.

FIG. 8 is a continuation of FIG. 7 illustrating the update management service using the algorithm for performing metadata updates.

FIG. 9 is a flow chart of a method of updating versions of a client software.

FIG. 10 is a flow chart of a method of determining the availability of updates.

FIG. 11 is a flow chart of a method of allowing an anonymous user to update a computer system.

### DETAILED DESCRIPTION

The following detailed description illustrates embodiments of the present disclosure. These embodiments are described in sufficient detail to enable a person of ordinary skill in the art to practice these embodiments without undue experimentation. It should be understood, however, that the embodiments and examples described herein are given by way of illustration only, and not by way of limitation. Various substitutions, modifications, additions, and rearrangements may be made that remain potential applications of the disclosed techniques. Therefore, the description that follows is not to be taken as limiting on the scope of the appended claims. In particular, an element associated with a particular embodiment should not be limited to association with that particular embodiment but should be assumed to be capable of association with any embodiment discussed herein.

Certain types of versions of client software can have data about materials (i.e., fluids, solid) embedded in the client software that is necessary for purposes of analysis. Client software that depends on this material data will often require periodic updating as new materials are added, mistakes in material data are discovered, or materials become obsolete. This update is coordinated at a central location (i.e., a remote server) where the material data and associated metadata, discussed below, is maintained. A client computer can coordinate with a central source of data at the central location to identify and retrieve new material and metadata updates.

Along with the material data, there is often metadata associated with the material data that will also periodically need to be updated. This metadata may relate to, but is not limited to, choosing mathematical models appropriate for use with the material data, definitions that helps a user in finding the data when using the client software, properties of the materials, and default values for these properties under certain environmental conditions.

Portions of the client software may be embedded into many different client computers. This has the side effect that there may be different versions of the client software using the material data and metadata concurrently. There may be material data updates that would be appropriate for use in, for example, Version A of the client software, but cause a catastrophic failure when Version B operates on the same data.

Finally, updates to material data need to be performed using a central repository of material data and metadata. This is to allow updates to be completed in one location and propagated to all installed instances of the client software in the field.

In summary, the method described herein is to provide (1) a mechanism for periodically to updating material data and metadata, (2) allow for the updates to happen without needing a full release of the client software, (3) allowing the updates to be propagated from a central location out to individual installs of the client software, (4) allow several concurrent versions of the client software to use the data and metadata updates from a single, local repository of the data, and (5) allow for the data to be retrieved that is appropriate for the version of the client software accessing the material data.

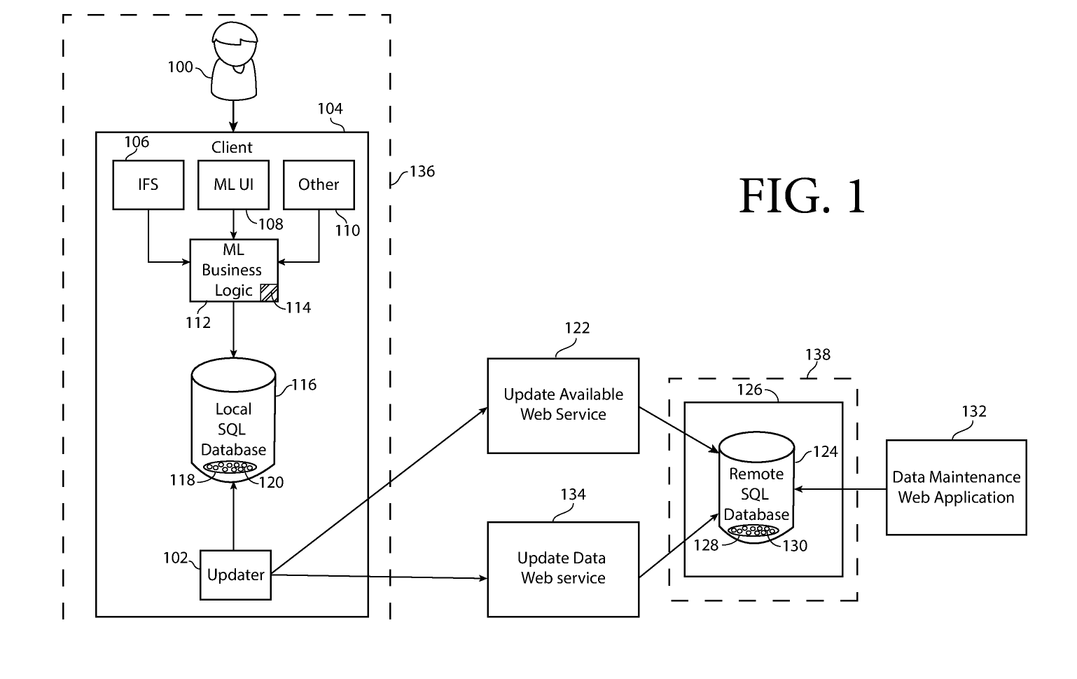

FIG. 1 is a block diagram illustrating a system for updating versions of a client software. The method includes an end-user 100 initiating an update management service 102 (illustrated as Updater 102) on a client computer 104. The end-user 100 may be an anonymous user (described in detail below). The client computer 104 may include a smart phone device (i.e., Apple iPhone®, Samsung Galaxy) or other such mobile device. The client computer 104 may include a personal desktop computer or a personal laptop computer.

Several generic applications are installed on the client computer 104, such as Halliburton's INSITE® for Stimulation (illustrated as IFS 106). The client computer 104 may also have installed on its hard-drive (not shown) a Materials Library User Interface (ML UI), which is illustrated as ML UI 108. The ML UI 108 may also be known as the material definition testing application. The client computer 104 may have other locally installed software (illustrated as Other 110) as needed.

The client computer 104 includes a Material Library Business Logic (illustrated as ML Business Logic 112) program that interfaces with the IFS 106, ML UI 108, and the Other 110 applications as needed. In one or more embodiments, the ML Business Logic 112 determines how data is created, displayed, stored, or changed. In one or more embodiments, the ML Business Logic program 112, the IFS 106, and the ML UI 108 are client software 114, each of which can have multiple versions. For example, the ML Business Logic program 112 may be version 1, the IFS 106 may be version 2, and ML UI 108 may be version 3. One version may be distinguished from another version simply by their respective release date or differences in their components. In some instances, components of one version may have components in common with another version. The version of the client software 114 may run as a standalone (i.e., independent of other software packages). The version of the client software 114 may be embedded in other software packages.

The ML Business Logic program 112 interfaces with an embedded database, which may be or may include, for example a local Structured Query Language Database 116 (illustrated as Local SQL Database 116), which is locally installed on the client computer 104. The Local SQL Database 116 includes a local repository 118, which stores material data and metadata (hereinafter collectively referred to as “metadata 120”). The local repository 118 may include a database (not shown for simplicity), which may also store the metadata 120. The database may include a relational database. Note, for simplicity, only one metadata 120 is labeled in the local repository 118.

The client computer 104 includes the update management service 102. The update management service 102 is the software program that manages the request for and installation of the metadata 120 for the client computer 104. The update management service 102 communicates with an update available web service 122 to determine if newer metadata updates are available for installation on the client computer 104. The update available web service 122 may be stored on a cloud network or remote server (not shown) separate from the client computer 104. That is, the update available web service 122 may be in a different location from the client computer 104, but remotely connected by a local area network (LAN) or wide area network (WAN) such as the Internet. The update available web service 122 may be unsecured, such that the end-user's 100 security credentials are not required to access the update web service 122. For example, an anonymous user can request the client computer 104 to communicate with the update available web service 122 to determine if updates (i.e., newer metadata) are available without requiring the end-user 100 to enter security credentials, such as a user-name and password, fingerprint, voice recognition, iris detection, or the like.

The update available web service 122 communicates with a remote SQL database 124 to determine if updates are available and, in some instances, manages the downloading of the newer metadata. In one or more embodiments, the Remote SQL CE Database 124 is installed on a remote server 126. The Remote SQL CE Database 124 includes a central repository 128, and a database (not shown for simplicity) which stores the newer metadata 130. The database may include a relational database. Note, for simplicity, only one newer metadata 130 is labeled in the central repository 128.

In one or more embodiments, a Data Maintenance Web Application 132 is used to facilitate the deployment of newer metadata 130 onto the central repository 128. As illustrated in FIG. 1, the Data Maintenance Web Application 132 communicates with the Remote SQL CE Database 124 to allow for the deployment of newer metadata 130.

If it is determined that newer metadata 130 is available, the update management service 102 communicates with an update data web service 134, which is a software program service that allows the update management service 102 to download the newer metadata 130 updates to the client computer 104. The update data web service 134 is secured, such that it will require the end-user's 100 security credentials to gain access to the available updates. The update data web service 134 will request the end-user 100 to provide security credentials before having access to the available updates. Once the security credentials are provided by the end-user 100, the update management service 102 will coordinate with the update data web service 134 to facilitate the downloading and installation of the newer metadata 130.

To facilitate communication, the local repository 118 is connected to the central repository 128 through a series of networks, which may include a local area network (LAN), wide area network (WAN), such as the Internet, or the like. The local repository 118 is located in a first location 136 (illustrated as the dashed box 136 around client computer 104). The update management service 102 copies from the central repository 128 the newer metadata 130 and an indication of the versions of client software 114 for which the newer metadata 130 is compatible. The central repository 128 is located in a second location 138 (illustrated as the dashed box 138 around the remote server 126). In one or more embodiments, the first location 136 and second location 138 are in different locations separated by the LAN or WAN. In one or more embodiments, the first location 136 and the second location 138 are the same location. For example, the client computer 104 may be directly connected to the remote server 128 or may be the same computer.

The update management service 102 updates a relation (such as a table in the relational database context) that identifies the metadata versions that are valid for each version of the client software 114 with the newer metadata 130 and an indication of which versions of the client software 114 are compatible with the newer metadata 130. The update management service 102 will then determine, that according to the relation, the version of the client software 114 is compatible with the newer metadata 130, which will then update the local SQL CE database 116 with the newer metadata 130.

The schema for the use of the metadata (i.e., metadata 120 and newer metadata 130) is the same with respect to the central repository 128 and the local repository 118. The difference, in one embodiment, is in the usage profile of each instance of data storage. For example, in the central repository 128 of data, the remote SQL CE database 124 is used in a read/write usage profile. It is intended that the central repository 128 mechanism (such as an SQL server) have many more capabilities for handling verification and organization of new material data (i.e., newer metadata 130).

In contrast, the local SQL CE database 116 is used in a read-only profile for the version of the client software 114, but in a read/write profile for the update management service 102. The update management service 102 ensures that an exact copy of the of the newer metadata 130 in the central repository 128 is recreated in the local repository 118. In one or more embodiments, the update management service 102 is selective about the newer metadata 130 that it copies, for example by copying only newer metadata 130 with specified validity dates. The update management service 102, along with data consistency and validation done on the central repository 128, enforce consistency in the local repository 118. Since data inside the version of the client software 114 is accessed using the local SQL database 116 as read-only, consistency and validation checks are not required by the version of the client software 114.

On any given installation location of the newer metadata 130, there may be multiple versions of the client software 114 (i.e., version 1, version 2 . . . and so on). Updated metadata 120, in some cases, is compatible across all versions of the client software 114. This is particularly true when new or updated metadata 130 is limited to using features of the versions of the client software 114 that are present in all released version.

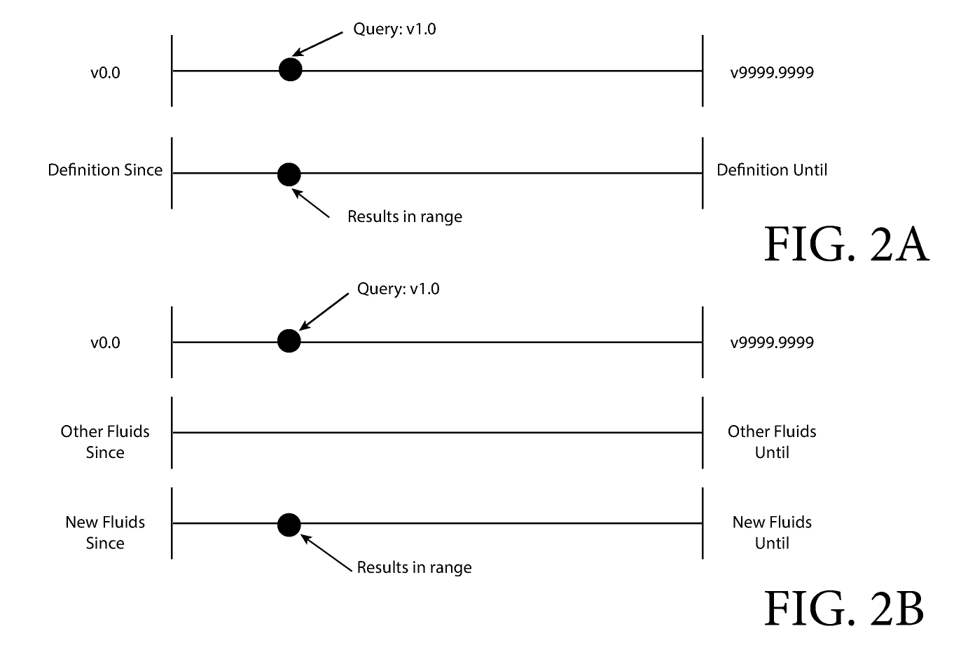

For example, FIG. 2A is a diagram illustrating a query result queried against a local repository when all metadata is tagged as compatible for all versions of the client software. As illustrated, the diagram shows a query result of Version 1 of the client software against the local repository 118 when all metadata (illustrated as range “Definition Since to Definition Until”) is tagged as compatible for all versions of the client software 114 (illustrated as range V0.0 to V999.9999). In this case, the diagram shows that the query results are in range, which means that all metadata is compatible to all versions of the client software 114, including version 1.0.

When newer metadata 130 is introduced into the query, a different analysis is taken. FIG. 2B is a diagram illustrating a query result when a newer metadata 130 is added that is compatible with all released versions of the client software. In addition to FIG. 2A, when newer metadata 130 is added (illustrated as range “New Fluid Since to New Fluid Until”) that is in the same range as the present metadata 120 (illustrated as range “Other Fluids Since to Other Fluids Until”), the new metadata 130 will be determined to be compatible because it is within the range of all the versions of the client software 114. Here, version 1 is queried against the newer metadata 130. The results (indicated by the bullet point “Results in range”) shows that the metadata is in range, and is compatible with version 1 of the client software.

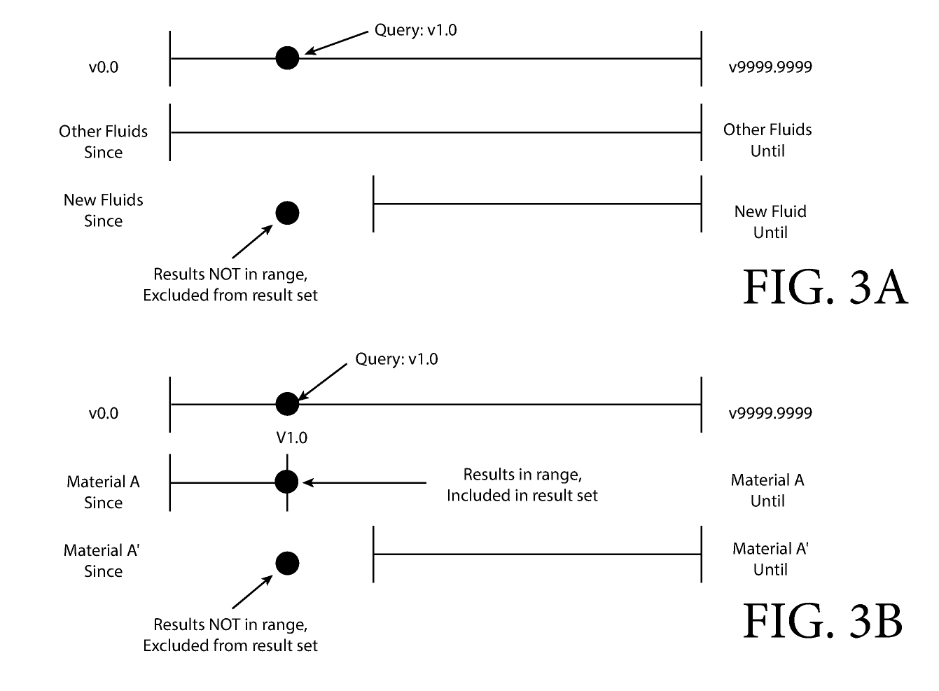

When newer metadata 130 is introduced that is not within the range, a different result is produced. FIG. 3A is a diagram illustrating a query result when a newer metadata 130 is added that is not compatible with all released versions of the client software. FIG. 3A is similar to the FIG. 2B, except that a new fluid (i.e., having newer metadata 130) has been added that is not compatible with an older version of the client software (i.e., version 1). Specifically, version 1 is queried against the new metadata 130. However, the new metadata 130 is not compatible with version 1. In that case, the new fluid is ignored by version 1 of the client software 114. Version 1 of the client software 114 would use the “other fluids” represented by the middle line of FIG. 3A.

The result is different when the metadata itself is updated with data that is not compatible with an older version of the client software. FIG. 3B. is a diagram illustrating a query result when an update to an existing metadata is incompatible with an older version of the client software. In this case, the compatibility with the older version is preserved as the new definition will only be seen by newer versions of the client software 114. For example, as illustrated in FIG. 3B, version 1 is queried against a compatible version of metadata (“Material A”). The query results show that Material A is compatible with Version 1, but Material A′ (which is Material A with the updated metadata) is incompatible with Version 1. In this case, Material A will be seen by Version 1, whereas Material A′ will not be seen.

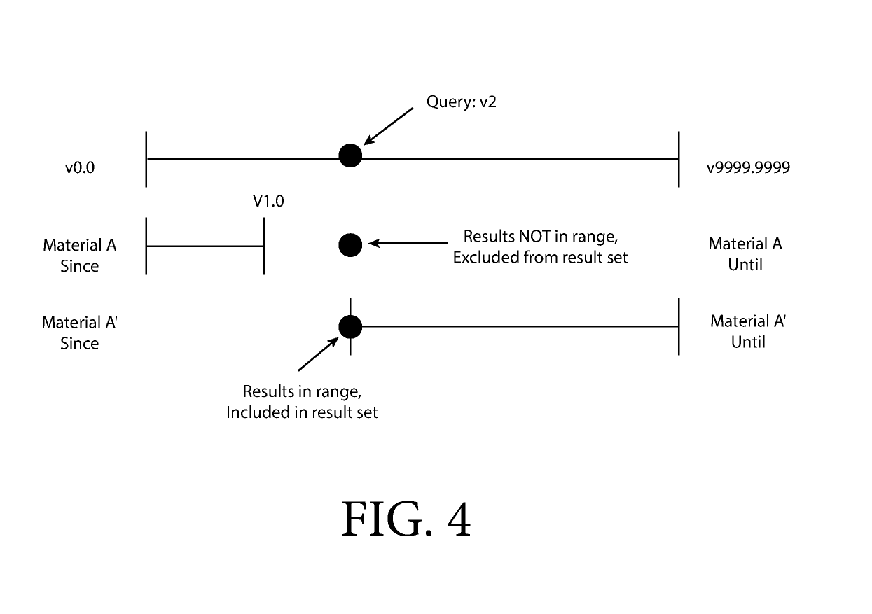

Query results with respect to a newer version of the client software 114 may produce different results. FIG. 4 is a diagram illustrating a query result when a newer metadata is retrieved when the local repository is queried by a newer version of the client software 114. As illustrated, Version 2 is queried against material A. However, Material A is only compatible with Version 1 of the client software, thus the metadata associated with Material A is ignored by Version 1 of the client software, but is seen by Version 2. A query of Version 2 against Material A′ produces an “in range” result.

Updates to material data and metadata can be provided via a data management application (not shown). This is an application that is strictly available to administrative personnel. The updates to the metadata can be deployed at any time without the need for a full software release effort. The effort required may be minimized to an automated regression test that verifies that updates received by a historic version of the client software can operate on the new materials definitions.

Retrieving updates in versions of the client software 114 at an inopportune moment can cause incorrect results to suddenly appear. The update management service 102 follows an algorithm that checks for the availability of updated data but requires the end-user 100 to accept the updated data before proceeding to perform the update.

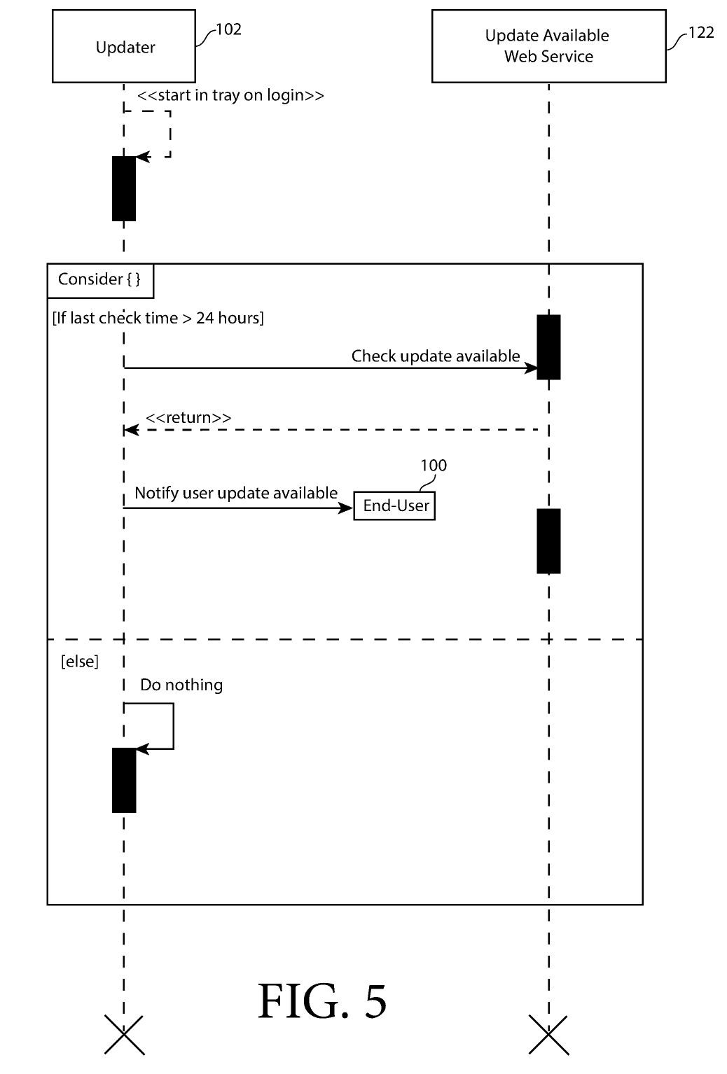

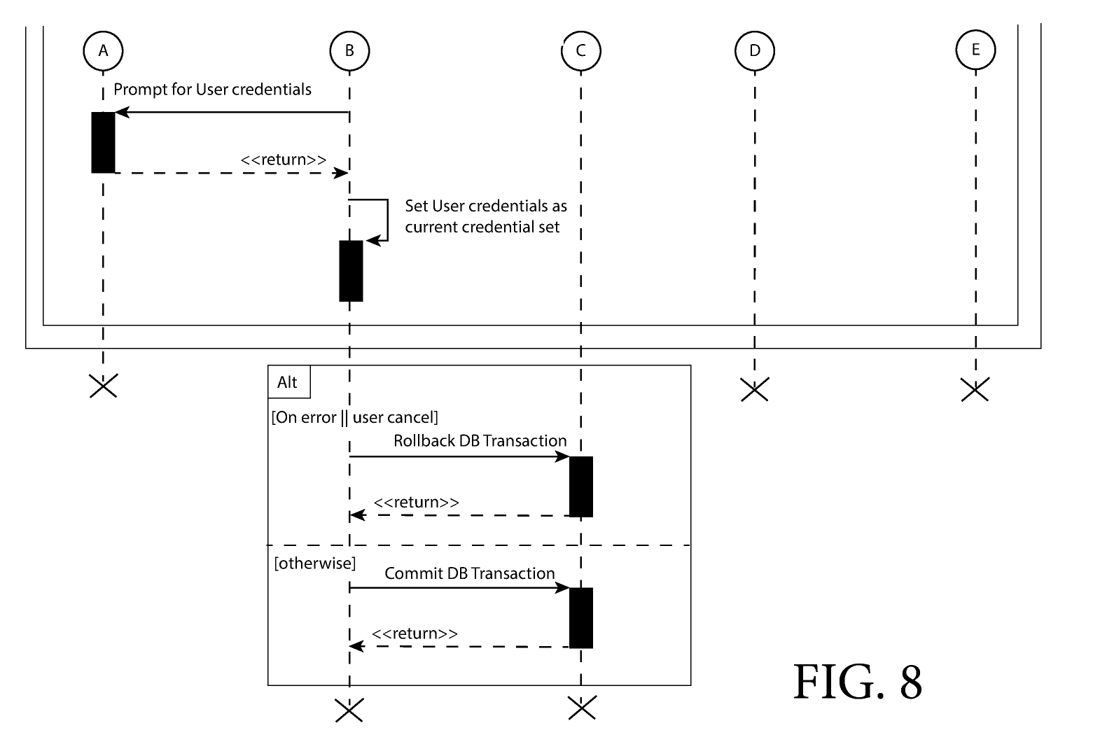

FIG. 5 is a swim lane diagram illustrating an update management service using an algorithm for checking the availability of newer metadata. Each “swim lane” in the diagrams of FIGS. 5-8 shows one component of the overall system. Each component may or may not exist on the same system. For example, an individual “swim lane” thread may run as part of the process flow. In one or more embodiments, each of the “swim lanes” may be executed multiple times in parallel with the other “swim lanes.” Time progresses from the top of the figure to the bottom of the figure. The elongated dark boxes in the swim lanes represent the passage of time. The “Xs” at the bottom of FIGS. 5 and 8 represent the end of processing for this particular iteration of a process. As illustrated, the update management service 102 (illustrated in FIG. 5 as Updater 102) will initiate from the system tray once the anonymous end-user 100 logs onto the client computer 104 (illustrated as dashed loop arrow labeled as <<start in tray on login>>). In cases in which the end-user 100 remains logged into the client computer 104 (i.e., end-user 100 does not log out of the client computer 104), the update management service 102 may have a 24-hour loop feature to determine periodically if updates are available (illustrated as “Consider { }, [If last check time>24 hours]). For example, the update management service 102 will determine if the last check for updates was made within the last 24 hours. If the update management service 102 has not checked for updates in more than 24 hours, then the update management service 102 will initiate the process of determining if updates are available by checking if updates are available (illustrated by the line from the Updater lane to the Update available web service lane labeled “check update available”) and receiving a notification (illustrated by the line from the Update available web service lane to the Updater lane labeled “<<return>>”). If the “return” indicates that updates are available, the update management service 102 notifies the end-user 100 of the available updates, for example using a pop-up banner that appears on a display available to the end-user 100. The 24-hour time limit may be adjusted to be less than or greater than 24 hours. If the update management service 102 determines that the last check was less than 24-hours ago, then the update management service 102 will not initiate (i.e., do nothing).

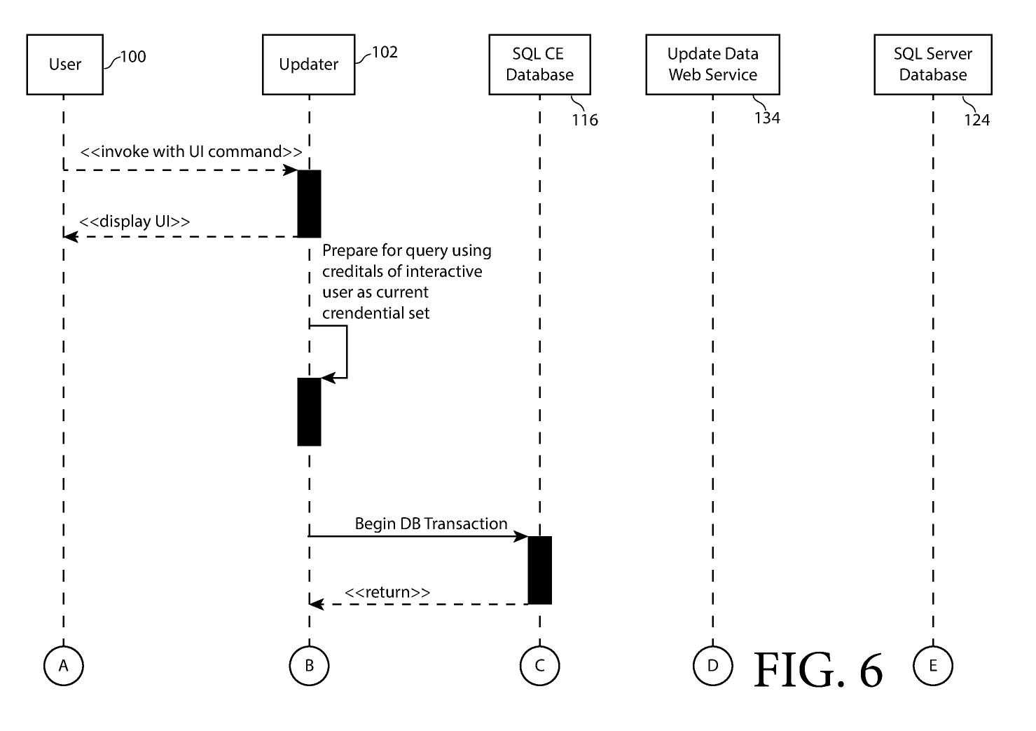

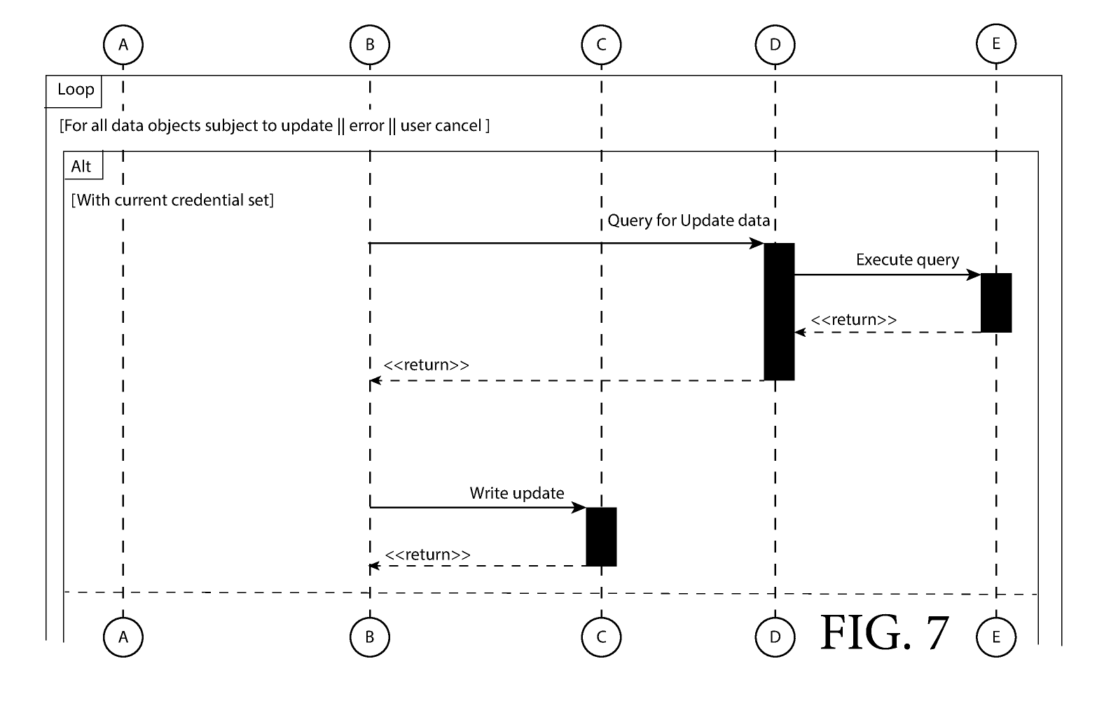

FIGS. 6, 7, and 8 are swim lane diagrams illustrating an update management service using an algorithm for performing metadata updates. Note in FIG. 6, lines A, B, C, D, and E are connected to lines A, B, C, D, and E in FIG. 7 to show that FIGS. 6 and 7 are connected. Further, lines A, B, C, D, and E in FIG. 7 are connected to lines A, B, C, D and E in FIG. 8 to show that FIGS. 6, 7, and 8 are all connected.

Minimizing incorrect results starts with the end-user 100, illustrated in FIG. 6, invoking the update management service 102 user interface (UI) command (illustrated as the dashed arrow labeled as <<invoke with UI command>> moving from line A to line B). In response, the update management service 102 displays through the UI (illustrated as the dashed arrow labeled as <<display UI>> from line B to line A) that it is preparing the query based on the end-user's 100 current security credential set. The update management service 102 will then initiate the database transaction (illustrated as the solid arrow labeled “Begin DB Transaction” from line B to line C) by first communicating with the local SQL database 116 to determine what metadata 120 is currently installed. The local SQL database 116 will return the results of that query to the update management service 102 (illustrated as the dashed arrow labeled <<return>> from line C to line B).

As illustrated in FIG. 7, the process enters a loop (illustrated by the word “Loop” in the upper left-hand corner) for all data objects subject to update (illustrated by “[For all data objects subject to update∥error∥user cancel]”).

In one or more embodiments, using the current security credential set (illustrated by the “[With current credential set]” label), the update management service 102 queries the update data web service 134 for available updates (illustrated as the solid arrow labeled “Query for Update data” from line B to line D). In response, the update data web service 134, knowing that updates are available, will execute a query of the remote SQL server database 124 to query for new data (illustrated as the solid arrow labeled “Execute query” from line D to line E). The remote SQL server database 124 will return the requested data to the update data web service 134. The update data web service 134 will then return the updated data to the update management service 102. The update management service 102 will write the previously-downloaded updates to the local SQL Database 116 (illustrated as solid arrow labeled “Write update” from line B to line C), which completes the operation. Note, the dashed arrows labeled <<return>> on the FIGS. 5-8 indicate transition from one “swim lane” to another.

As illustrated in FIG. 8, which illustrates how the “current credential set” is established, the update management service 102 (indicated by line B) prompts the end-user 100 for the security credentials (illustrated as solid arrow labeled “Prompt for User credentials” from line B to line A). As discussed above, security credentials are not necessary for the update management service 102 to determine if updates are available, but are necessary to retrieve the updates. If the end-user 100 does not know their security credentials, then the process is canceled or if the end-user 100 fails to enter the correct security credentials, then the process response in error, thus terminating the process. The end-user 100 responds to the update management service 102 by entering the security credentials (illustrated by the dashed arrow labeled <<return>> from line A to line B). The “current credential set” must be valid for the “[With current credential set]” box to execute. If the current credentials are not valid, the update management service 102 executes the “prompt user for credentials” process, sets the provided credentials as the current credentials, and then re-executes the loop “[For all data objects subject to update∥error∥user cancel]”. If the credentials are wrong, then the update management service 102 asks again.

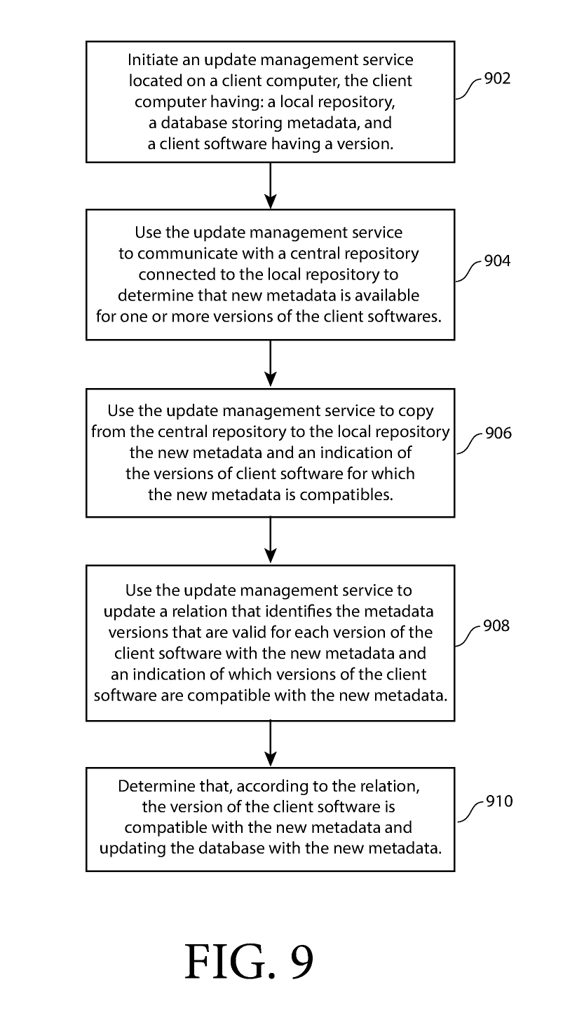

FIG. 9 is a flow chart of a method of updating versions of a client software. In operation, an update management service (such as update management service 102) located on a client computer (such as client computer 104) is initiated, the client computer (such as client computer 104) having: a local repository (such as local repository 118), a database storing the metadata (such as metadata 118), and a client software having a version (such as version of client software 114)(block 902). The update management service (such as update management service 102) communicates with a central repository (such as central repository 128) connected to the local repository (such as local repository 118) to determine that new metadata (such as newer metadata 130) is available for one or more version of the client software (such as version of client software 114)(block 904). The update management service (such as update management service 102) copies from the central repository (such as central repository 128) to the local repository (such as local repository 118) the new metadata (such as newer metadata 130) and an indication of the versions of client software (such as version of client software 114) for which the new metadata (such as newer metadata 130) is compatible (block 906). The update management service (such as update management service 102) updating a relation that identifies the metadata (such as newer metadata 130) that are valid for each version of the client software (such as version of client software 114) with the new metadata (such as newer metadata 130) and an indication of which versions of the client software (such as version of the client software 114) are compatible with the new metadata (such as newer metadata 130)(block 908). Determining that, according to the relation, the version of the client software (such as version of client software 114) is compatible with the new metadata (such as new metadata 130) and updating the database with the new metadata (such as newer metadata 130)(block 910).

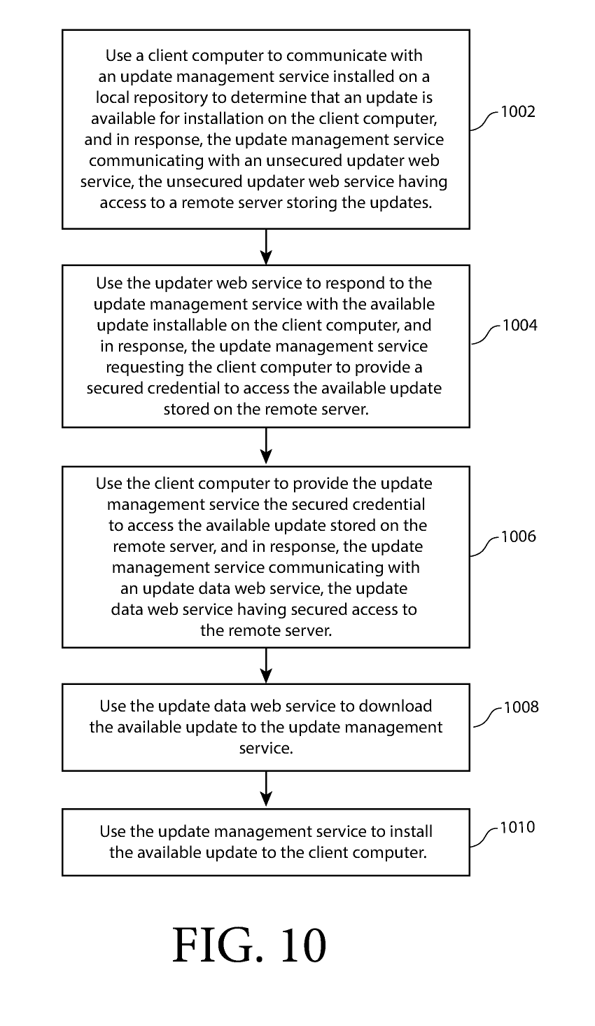

FIG. 10 is a flow chart of a method of determining the availability of updates. In operation, a client computer (such as client computer 104) communicates with an update management service (such as update management service 102) installed on a local repository (such as local repository 118) to determine that an update is available for installation on the client computer (such as client computer 104), and in response, the update management service (such as update management service 102) communicates with an unsecured updater web service (such as update available web service 122), the unsecured updater web service (such as update available web service 122) having access to a remote server (such as remote server 126) storing the updates (block 1002). The updater web service (such as update available web service 122) responds to the update management service (such as update management service 102) with the available update installable on the client computer (such as client computer 104), and in response, the update management service (such as update management service 102) requesting the client computer (such as client computer 104) to provide a secured credential to access the available update stored on the remote server (such as remote server 126)(block 1004). The client computer (such as client computer 104) provides the update management service (such as update management services 102) the secured credential to access the available update stored on the remote server (such as remote server 126), and in response, the update management service (such as update management service 102) communicates with an update data web service (such as update data web service 122), the update data web service (such as update data web service 122) having secured access to the remote server (such as remote server 126)(block 1006). The update data web service (such as update data web service 134) downloads the available update to the update management service (such as update management service 102)(block 1008). The update management service (such as update management service 102) installs the available update to the client computer (such as client computer 104)(block 1010).

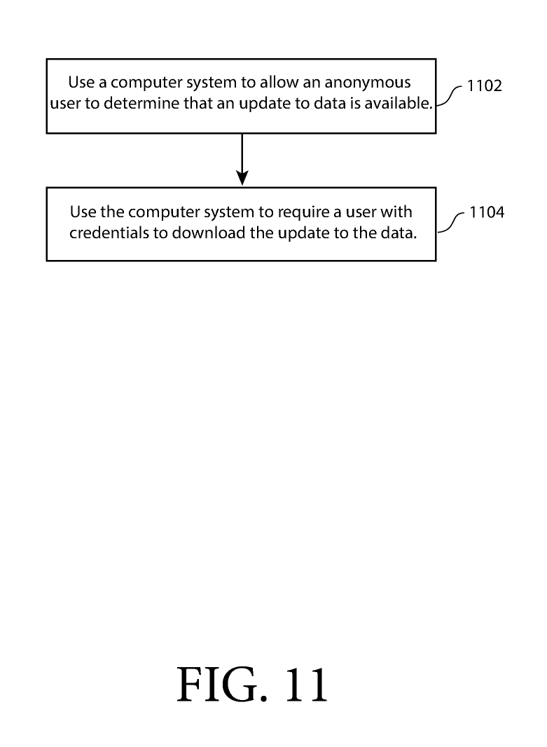

FIG. 11 is a flow chart of a method of allowing an anonymous user to update a computer system. In operation, a computer system (such as client computer 104) allows an anonymous user (such as end-user 100) to determine that an update (such as new metadata 130) to data (such as metadata 120) is available (block 1102). The computer system (such as client computer 104) requires a user (such as end-user 100) with credentials to download the update (such as new metadata 130) to the data (such as metadata 120)(block 1104).

In one aspect, a method includes initiating an update management service located on a client computer. The client computer has a local repository, a database storing metadata, and a client software having a version. The update management service communicates with a central repository connected to the local repository to determine that new metadata is available for one or more versions of the client software. The update management service copies from the central repository to the local repository the new metadata and an indication of the versions of client software for which the new metadata is compatible. The update management service updates a relation that identifies the metadata versions that are valid for each version of the client software with the new metadata and an indication of which versions of the client software are compatible with the new metadata. It is determined that, according to the relation, the version of the client software is compatible with the new metadata and updates the database with the new metadata.

Implementations may include one or more of the following. The metadata may include property information about a material. The version of the client software may be embedded in a plurality of client computers. The version of the client software may be installed on the client computer as a standalone application. The local repository may be configured with a read-only profile when being accessed by the client software. The local repository may be configured with a read/write profile when being accessed by the update management service. The database may include a relational database. The computer may be a mobile device.

In one aspect, a method includes a client computer communicating with an update management service installed on a local repository to determine that an update is available for installation on the client computer. In response, the update management service communicates with an unsecured updater web service. The unsecured updater web service has access to a remote server storing the updates. The updater web service responds to the update management service with the available update installable on the client computer. In response, the update management service requests the client computer to provide a secured credential to access the available update stored on the remote server. The client computer provides the update management service the secured credential to access the available update stored on the remote server. In response, the update management service communicates with an update data web service. The update data web service has secured access to the remote server. The update data web service downloads the available update to the update management service and the update management service installs the available update to the client computer.

Implementations may include one or more of the following. The local repository may be located on the client computer. Providing a secured credential may include providing a username and password. Providing a secured credential may include providing a thumb print.

In one aspect, a method includes a computer system allowing an anonymous user to determine that an update to data is available and the computer system requiring a user with credentials to download the update to the data.

Implementations may include one or more of the following. The computer may be a mobile device. The data may be located on a remote server. The computer system may be located in a first location and the remote server may be located in a second location. The first location and second location may be the same. The data may include metadata.

References in the specification to “one or more embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

The word “coupled” herein means a direct connection or an indirect connection.

The text above describes one or more specific embodiments of a broader invention. The invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
initiating an update management service located on a client computer, the client computer having:
a local repository;
a database storing metadata; and
a client software having a version;
the update management service communicating with a central repository connected to the local repository to determine that new metadata is available for one or more versions of the client software;
the update management service copying from the central repository to the local repository the new metadata and an indication of the versions of client software for which the new metadata is compatible;
the update management service updating a relation that identifies the metadata versions that are valid for each version of the client software with the new metadata and an indication of which versions of the client software are compatible with the new metadata; and
determining that, according to the relation, the version of the client software is compatible with the new metadata and updating the database with the new metadata.

2. The method of claim 1 wherein the metadata includes property information about a material.

3. The method of claim 1 wherein the version of the client software is embedded in a plurality of client computers.

4. The method of claim 1 wherein the version of the client software is installed on the client computer as a standalone application.

5. The method of claim 1 wherein the local repository is configured with a read-only profile when being accessed by the client software.

6. The method of claim 1 wherein the local repository is configured with a read/write profile when being accessed by the update management service.

7. The method of claim 1 wherein the database comprises a relational database.

8. The method of claim 1 wherein the computer is a mobile device.

9. A method comprising:
a client computer communicating with an update management service installed on a local repository to determine that an update is available for installation on the client computer, and in response, the update management service communicating with an unsecured updater web service, the unsecured updater web service having access to a remote server storing the updates;
the updater web service responding to the update management service with the available update installable on the client computer, and in response, the update management service requesting the client computer to provide a secured credential to access the available update stored on the remote server;
the client computer providing the update management service the secured credential to access the available update stored on the remote server, and in response, the update management service communicating with an update data web service, the update data web service having secured access to the remote server;
the update data web service downloading the available update to the update management service; and
the update management service installing the available update to the client computer.

10. The method of claim 9 wherein the local repository is located on the client computer.

11. The method of claim 9 wherein providing a secured credential comprises providing a username and password.

12. The method of claim 9 wherein providing a secured credential comprise providing a thumb print.

13. A method comprising:
a computer system allowing an anonymous user to determine that an update to data is available; and
the computer system requiring a user with credentials to download the update to the data.

14. The method of claim 13 wherein the computer is a mobile device.

15. The method of claim 13 wherein the data is located on a remote server.

16. The method of claim 13 wherein the computer system is located in a first location and the remote server is located in a second location.

17. The method of claim 16 wherein the first location and second location are the same.

18. The method of claim 13 wherein the data comprises metadata.
